(19) United States
(12) Patent Application Publication
(10) Pub. No.: US 2022/0101398 A1
(43) Pub. Date: Mar. 31, 2022

(54) System and method for the direct and indirect real time pairing of digital inventories

(71) Applicants: Abraham Isaac Santiago-Rivera, Apopka, FL (US); Jesus Eugenio Santiago-Rivera, Apopka, FL (US)

(72) Inventors: Abraham Isaac Santiago-Rivera, Apopka, FL (US); Jesus Eugenio Santiago-Rivera, Apopka, FL (US)

(21) Appl. No.: 17/033,769

(22) Filed: Sep. 26, 2020

(51) Int. Cl. G06Q 30/06

(52) U.S. Cl. CPC G06Q 30/0611; G06Q 30/0635; G06Q 30/0627; G06Q 30/0641

(57) ABSTRACT

An automated computer-readable algorithm designed to generate user links, constituting an indirect match or direct match, among a multitude of users; whereby, said user links will be generated by extracting data from a multitude of published inventories.

### STATEMENT REGARDING FEDERALLY SPONSORED RESEARCH AND DEVELOPMENT

N/A

### RELATED APPLICATIONS

N/A

### BACKGROUND OF THE DISCLOSURE

### Field of the Invention

The present invention relates to the field of automated matching processes, specifically related to providing a programmable algorithm designed to generate user links connecting automatically by constituting an indirect or direct match.

### Discussion of the Background

Past prior art mostly presents automated match algorithms designed to generate suggestions based on user past interest in broad item categories. The Internet comprises a series of platforms designed for publishing electronic listings and provide exchange services, geared to conduct direct match transactions among a plurality of users. These platforms are dedicated to store electronic listings serve as a static bulletin board connected through a user interphase; utilized to seek a specific need within the platform's database. However, most of these platforms lack the validation of availability of published listings as well as the real time connections, required to establish timely transactions among users. Thereby, said platforms display listings that are no longer available, while providing the user with a unique search, limited to the time spend on their platforms. Prior art, provided the basis in which most algorithm find items for users, utilizing their past conduct based on their selected or searched items. While most of these algorithm are highly efficient, the majority of them, don't provide the user the exact items they want. Such items are found by users through the constant scanning of published content within the platform. As described more fully below, the present invention improves the prior art by providing a direct match in real time, of wanted items; that are connected through the content of “Have” and “Want” listings contained in the inventories of a multitude of users.

Conversely, the Internet also comprises a series of exchange services for items offered through online or physical barter networks, designed to generate indirect match among a plurality of users. Modern exchange systems emulate current monetary systems by issuing their own barter currency, often times pegged with the value of their country's currency. Traditional offline barter networks usually al-locate human resources and charge commission fees, to serve as an exchange intermediary among associates using a private or web based platform within the network to connect its user base. With the invention of the Internet global opportunities have arisen. Many exchange networks and business applications have developed programmable algorithms that serve as an automated intermediary among participants. These algorithms are designed to find coincidence of needs based on published “haves” and “wants” of users, categories of interest and item suggestions according to user past history. However, most of these approaches lack of mutual interest among users in regards to the items contained within a multiple exchange offer. For example, a user may announce he wants a car in his “Want” list; however, he might be interested in a particular car make, a specific year or model. The fact current systems are automated and just designed to match according to a defined category without deploying specific criteria, may lead to a lot of time waste in the final decision outcome.

Prior art methods allowed a user to reduce their exchange search endeavors; proving beneficial for generating stand alone item options for a dual exchange process or transaction. As described more fully below, the present invention improves the prior art by providing multiple alternatives to simultaneously meet the users needs in a direct business transaction or group exchanges. Wherein a multiple exchange engine would generate automated matches based on customizable parameters, providing wanted items for a plurality of exchange groups.

The shortcomings with static platforms, utilized for publishing of electronic listings, is that it assumes that users have unlimited time to scan through a multitude of search results; in order to find a direct match about their wanted items. Furthermore, most of these platforms don't feature publishing of a “Want” as an electronic search, as a means to create a direct match with any “Have” content within an online platform. Wherein said platforms also lacks the possibility of establishing a plurality of real time searches of wanted items within a same timeline. Also most electronic listings platforms don't utilize automated algorithms to systematically discard matching items pertaining to inactive users; that are no longer engaging within their platforms.

Other shortcomings of prior arts designed for generating indirect match through an exchange process, is that they assume that a user selected category would reflect broad interest on random items contained within the category. Also, some exchange processes assume that there in no need for price equilibrium within the exchange process. Other approaches such as physical or online barter networks utilize alternative currencies to aid with the exchange process. However, these methods lack scalability, due to the alternative currency limited acceptance within the main-stream economy. These methods fall short because they do not exploit automation to deliver a synergistic exchange process in where a group obtain wanted items in a price equilibrated transaction.

### OBJECTS AND SUMMARY OF THE INVENTION

An object of the present disclosure is to provide an automated method through a computer readable algorithm, that will generate direct and indirect match among items pertaining to a multitude of users. Wherein said automated algorithm will generate an inventory of items constituting a direct match in real time, any time a user publishes an electronic listing. Whereby a user can publish a “Want” or “Have” as an electronic listing, thereby generating a plurality of user links constituting a direct match. Said automated algorithm provides direct match results by scanning the content relevance among published “Have” listings and “Want” listings; wherein, it continuously scans for electronic listings constituting a direct match, even when a user is offline. The process and method herein establishes the process from which all published items by users will automatically find matching connections among a multitude of participants.

It is another object of the present invention to provide an automated method whereby the algorithm constantly up-dates the inventory of items constituting a direct match; wherein the algorithm automatically replaces an item constituting a direct match any time said listing is granted within another accepted transaction. Further, another object of the present invention is to automatically replace items constituting a direct or indirect match; any time the owners of said items are inactive within the platform for a predetermined period of time selected by the algorithm's administrator.

Another object of the present disclosure is to provide an automated method to connect listings constituting an indirect match through a multiple exchange chain, for a plurality of users. Wherein coincidence of needs among the “Offer's Originator” and the “Offer's Recipient” is non existent; whereby, the automated algorithm would provide wanted items to all or most of the users within a multiple exchange transaction. In the event of missing user links within a group exchange, the algorithm will extract data from the “Market Wants” database to generate new connections.

Thereon, user links constituting an indirect match are generated for three or more users wanting to exchange goods and services; with or without monetary exchange. Wherein the algorithm generates an indirect match through a multiple exchange chain, by scanning information through a plugin named “Want” comprised on all goods and services listings; it also extracts data from electronically published “Want” and “Have” listings by a plurality of users. The data is processed through customizable parameters such as location, desired amount of participants and price range. The algorithm will generate a graphical representation of a multiple exchange chain for all involved users; thus, producing an equalized transaction of wanted items by most or all users. Wherein the constituted users within a multiple exchange chain or within any direct match, may manually curate and discard the resulting matches. Thereof, manually executing the algorithm through the user's interphase to automatically replace a user link constituting a direct or indirect match.

It is the object of this invention to present a social plugin named “Want”; wherein said plugin would serve as a catalyst in accelerating a multiple exchange process among a multitude of users. The plugin may be encompassed in online electronic publications related to goods and services; constituted within or detached from the algorithm's platform. All gathered data through the “Want” plugin will be invoked by the automated algorithm to generate dual and multiple exchange alternatives.

It is another object of the present invention to utilize the “Want” plugin as a barometer of user wants, in relation to a plurality goods and services categories contained within diverse geographic areas. Therefore, essentially serving as a connection tool to help item owners to connect directly with their end costumer and viceversa. The plugin may be provided over a communication network such as the Internet, a website, web platform, application software, web based program or any related technology.

Yet, another object of the present invention is to utilize the “Want” plugin to build a customized database based on desired items for a plurality of users. Said customized database will help generate random user links, to complete non-existent user links within a multiple exchange construction. Wherein said random user links would be automatically selected based on the user's click history gathered through the “Want” plugin.

Another object of the present invention is to provide a process and method to construct automated multiple exchange transactions, wherein user links are added both forward and backwards in a multiple exchange construction. Wherein, the system extracts data from the item in the back and the user in front throughout a multiple exchange construction, to complete a multiple exchange chain. This process adds user links to create a final graphical representation of the multiple exchange chain.

The invention itself, both as to its configuration and its mode of operation will be best understood, and additional objects and advantages thereof will become apparent, by the following detailed description of a preferred embodiment taken in conjunction with the accompanying drawings.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentable and non-obviously distinct invention. The Applicant hereby asserts, that the disclosure of the present application may include more than one invention, and, in the event that there is more than one invention, that these invention may be patentable and non-obvious one with respect to the other.

Further, the purpose of the accompanying abstract is to enable the U.S. Patent and Trademark Office and public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims nor is it intended to be limiting as to the scope of the invention in any way.

### BRIEF DESCRIPTION OF THE DRAWINGS

The accompanying drawings which are incorporated herein constitute part of the specifications and illustrate the preferred embodiment of the invention.

FIG. 1 shows the process of a preferred exemplary embodiment, in accordance with the principles of the present disclosure, of the “Multiple Exchange Engine” and the interactions with the “Reverse Match” subprocess to add user links that generate a graphical representation of a final exchange chain.

FIG. 2 shows the process of a preferred exemplary embodiment, in accordance with the principles of the present disclosure, of the interactions of the “Reverse Match” subprocess with two additional subprocesses titled “Last Match” and “Front Match”. Wherein, the “Reverse Match” subprocess will extract data from the item at the back of a multiple exchange construction, to add additional user links in the back of a multiple exchange chain.

FIG. 3 shows the process of a preferred exemplary embodiment, in accordance with the principles of the present disclosure, of a subprocess titled “Last Match” extracting data from the user at the front of a multiple exchange construction. Wherein, it simultaneously extracts data from the item owned by the user at the back in a multiple exchange construction, to find coincidence of needs on the last link closing the multiple exchange chain.

FIG. 4 shows the process of a preferred exemplary embodiment, in accordance with the principles of the present disclosure, of a subprocess titled “Front match” extracting data from the user at the front of a multiple exchange construction, to add additional user links in the front of a multiple exchange chain.

FIG. 5 shows the process of a preferred exemplary embodiment, in accordance with the principles of the present disclosure, of an automated process titled “Have Match” executing in real time, to generate a plurality of direct match alternatives, any time a “Have” listing is published.

FIG. 6 shows the process of a preferred exemplary embodiment, in accordance with the principles of the present disclosure, of an automated process titled “Want Match” executing in real time, to generate a plurality of direct match alternatives, any time a “Want” listing is published.

FIG. 7 shows the process of a preferred exemplary embodiment, in accordance with the principles of the present disclosure, of a user's interphase designed to customize user link addition utilizing filters parameters for a multiple exchange transaction.

FIG. 8 shows a system illustration of a preferred exemplary embodiment, in accordance with the principles of the present disclosure, of the software and system platform interaction.

### DESCRIPTION OF THE PREFERRED EMBODIMENT

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

Further, for purposes of this discussion, the term “user” may include at least a person, group of people, company, any other legal entity or any combination thereof that accesses by a programmable device the current system.

Further for purposes of this discussion, the term “Have” use for listings comprises any type of published electronic listing that entails ownership of goods, legal control on goods, legal permit to publish such goods or any combination thereof. It also comprises any type of published electronic listings by a user that entails the ability to provide skilled service through their own competence; through a partnership with service providers, through legal control constituting the right publish skilled services from third parties or any combination thereof.

All electronically published goods and services listings within the algorithm's platform would contain a social plugin named “Want”. The plugin name may be exchanged to any dissimilar word, verb, lexicon or any combination thereof; serving the same purpose. Wherein, said plugin is utilized by the algorithm to store and extract data, to generate user links constituting a future indirect match through an exchange chain.

The term “Want” may constitute any type of published electronic listings that entails the search of any goods and services, within a specific area and price range. Furthermore, the term “Want” may be used interchangeable to constitute a real time search, signal interest, generate user links or any combination thereof.

The term “Market Wants” includes all gathered data constituted within the database; wherein, said data involves clicks data generated by users utilizing the “Want” plugin, comprised on goods and services listings. It also encompasses data generated through the electronic publishing of “Want” and “Have” listings or any combination thereof.

For purposes of this present invention the following disclosure applies, an “Offer's Recipient” is a user that receives a multiple exchange offer encompassing his published item. Conversely, a “Offer's Originator” is a user that initiates an automated multiple exchange offer encompassing any published item he is interested in.

Furthermore, for purposes of the present invention discussion when its referred to the term “User link”, its refers to the connection among users through their published item inventories. Wherein a plurality of users will automatically connect their electronic inventories through the “Multiple Exchange Engine”. Said “User links” represent connections among two users, with their connection endings directing towards one same direction. Wherein, one of said connection endings will connect to one the involved users. Therefore once all “User links” are added, they will form a virtual chain representing a multiple exchange transaction.

One embodiment of the present invention comprises several distinct functions such as connecting users by means of their items inventories through the constitution of a direct or indirect match generated by an algorithm. The algorithm works synergistically to update the provided inventory of matching goods and services in real time. Said method continuously actualize the provided alternatives constituting a direct and indirect match, by automatically discarding granted items within other transactions. It also discards items from owners that are not engaging within the platform for a predetermined period of time; wherein said time is selected by the algorithm's administrator. Finally, the users too may manually discard match results provided by the algorithm constituting either a direct or indirect match. Wherein users may discard a plurality of matching results, automatically activating the algorithm to replace them for new match alternatives.

One embodiment of the present invention is the real time generation of user links constituting a direct match alternatives; produced by the automated matching algorithm, through the sorting of content relevance among electronically published “Have” and “Want” listings. Wherein, a user can generate simultaneous searches in real time, encompassing wanted items; whereby the algorithm will keep scanning the database and sorting data by relevance even if the user is offline. Hence, the algorithm can generate a plurality of results constituting a direct match for either a “Want” or “Have” listing. Said matching results are updated automatically by the algorithm, each time an item within that inventory is granted within a transaction or multiple exchange chain. The algorithm also replaces items owned by inactive users within an online platform; wherein a predetermined period of time is selected by the algorithm's administrator. Furthermore, a user may discard manually any generated matching result and the algorithm will automatically replace it with a new alternative.

Another embodiment of the present invention is the generation of results constituting an indirect match through a multiple exchange chain; encompassing wanted items by the users within the chain. The automated system and method generates a multitude of real time connections among users and store it within its database; wherein said data is stored as user links, for future multiple exchange constructions. Wherein a multiple exchange chain will be constructed based on the stored data by the “Want” plugin, all electronically published “Want” listings and all electronically published “Have” listings. Furthermore, the algorithm customizes a multitude of users needs in real time, collected through the “Want” plugin, comprised on all good and services listings. Wherein users also customize their needs, through the electronic publishing of “Want” listings constituting a specific request for goods or services, a location and their desired price range. In the occurrence of missing user links within a multiple exchange construction, the automated process will extract data from the user on front of said structure; wherein the suggested user link will be based on the personal “Market Wants” history pertaining to that user.

Following is a more detailed description in view of the figures.

### Multiple Exchange Chain

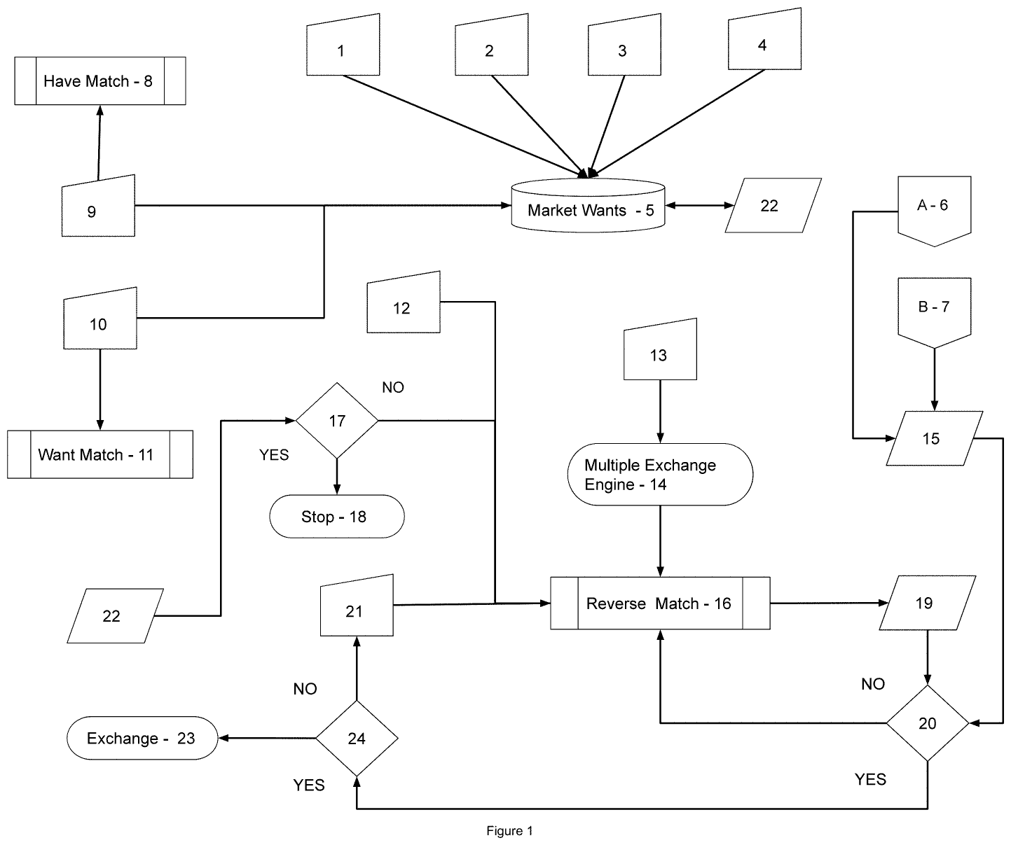

The illustrated process on FIG. 1 in accordance with the principles of the present invention constitutes an automated process for building a multiple exchange chain. All electronically published goods and services listings will comprise a plugin named “Want”; wherein, said plugin will catalyze the real time customization of a multitude of user needs. The “Want” inventory collected through said plugin, constitute users owning each a plurality of item inventories. Furthermore, each time an electronically published “Want” listing 10 is generated by users or a random user clicks on the “Want” plug-in 1,2,3 and 4; or any combination thereof, the algorithm stores said information on its database 5 for future multiple exchange constructions. Said stored information further comprises a methodology for systematically measuring users interest in real time, through their selections of goods and services 1,2,3 and 4; wherein said data is invoked by the “Reverse Match” subprocess 16 to generate a multiple exchange chain.

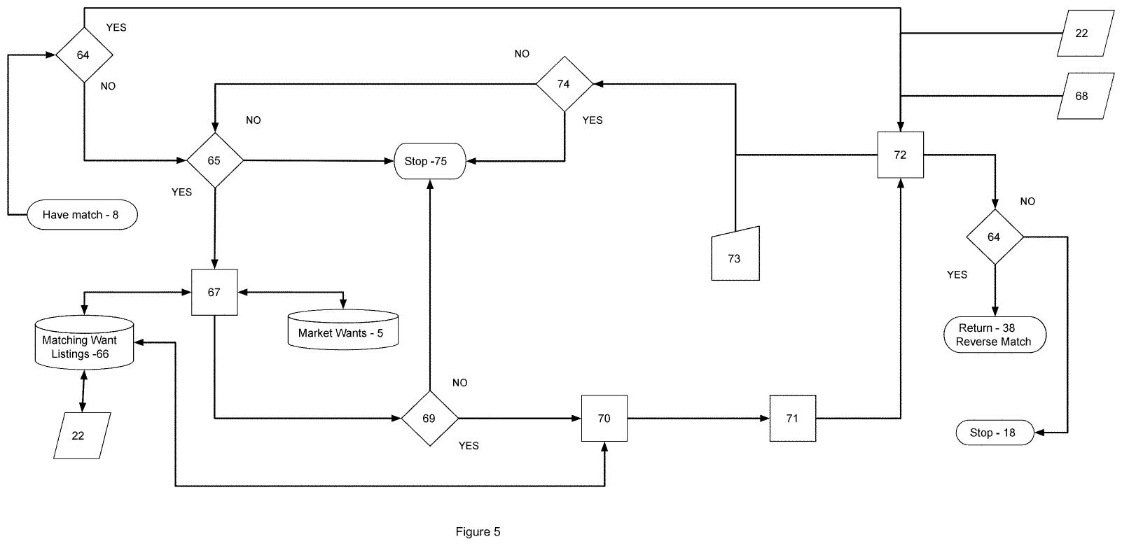

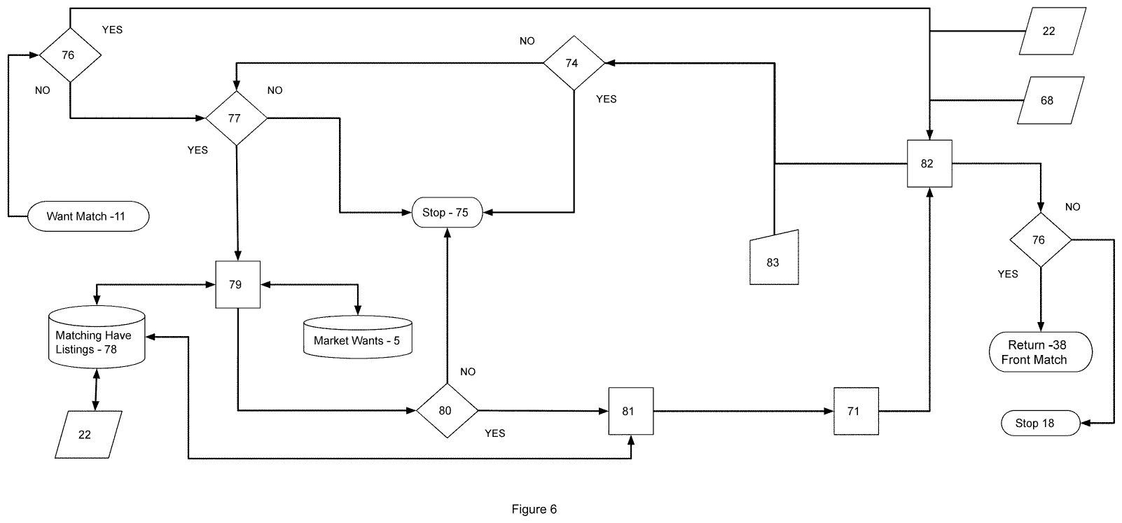

The multiple exchange algorithm activate the “Want Match” 11 and “Have Match” 8 subprocesses, any time an electronically published “Have” 9 or “Want” 10 listing is created. The subprocess named “Have Match” 8 generates a plurality of users with coinciding “Want” listings 10. Conversely, the subprocess named “Want Match” 11 generates a plurality of users with coinciding “Have” listings 9. Wherein the automated algorithm generates results in real time and attaches the matching inventory in relation with the listings generated by users. Therefore, a multitude of results constituting a direct match will be generated for a multitude of electronically published listings. This process will become more apparent on FIGS. 5 and 6 discussed hereinafter.

The process on FIG. 1 starts generating multiple exchange options once a “Offer's Originator” invokes the algorithm within the platform through a simple offer 13. Wherein, the algorithm generates exchange chains, by the means of storing and extracting data based on the inputs produced by users. Said data is generated through clicks on the “Want” plugin 1,2,3,4 and through the electronic publishing of “Want” 10 and “Have” 9 listings or any combination thereof.

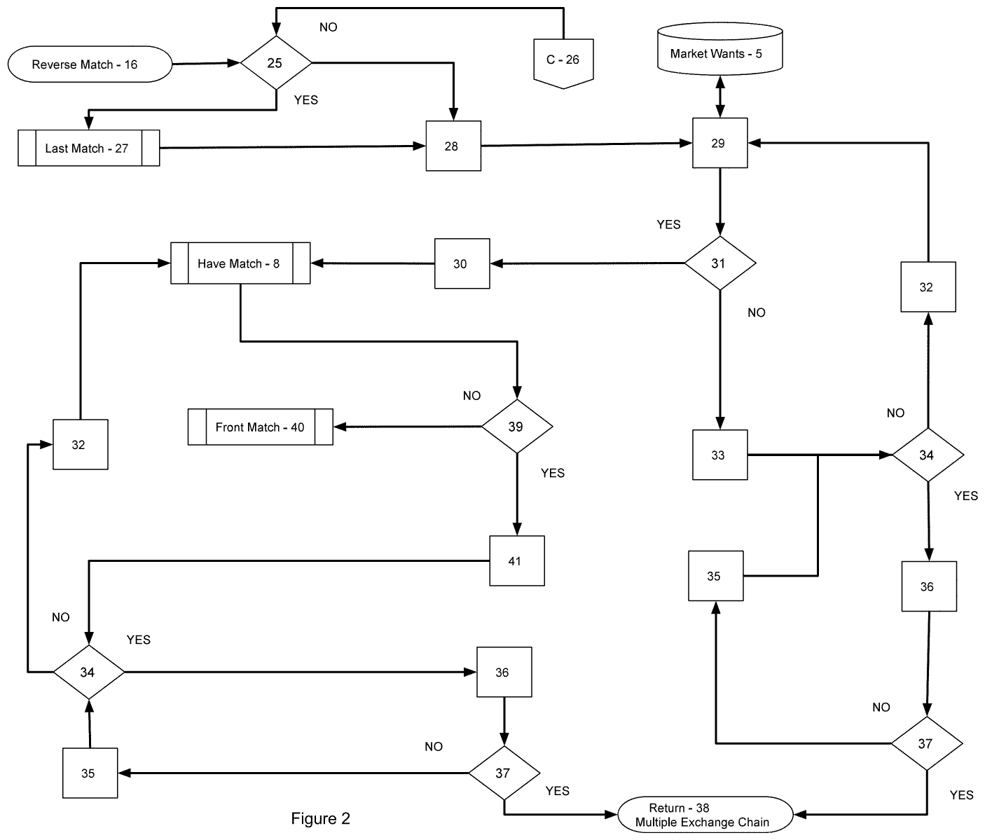

The multiple exchange engine 14 initializes, by invoking the “Reverse Match” subprocess 16. Wherein said subprocess initially extracts data from the item provided by the “Offer's Originator” 14; thereby, said subprocess will generate user links at the back of a multiple exchange construction in step 19. The “Reverse Match” subprocess 16 will become more apparent on FIG. 2. by detailing the process through which the algorithm utilizes the item's collected data to connect further users within a multiple exchange chain.

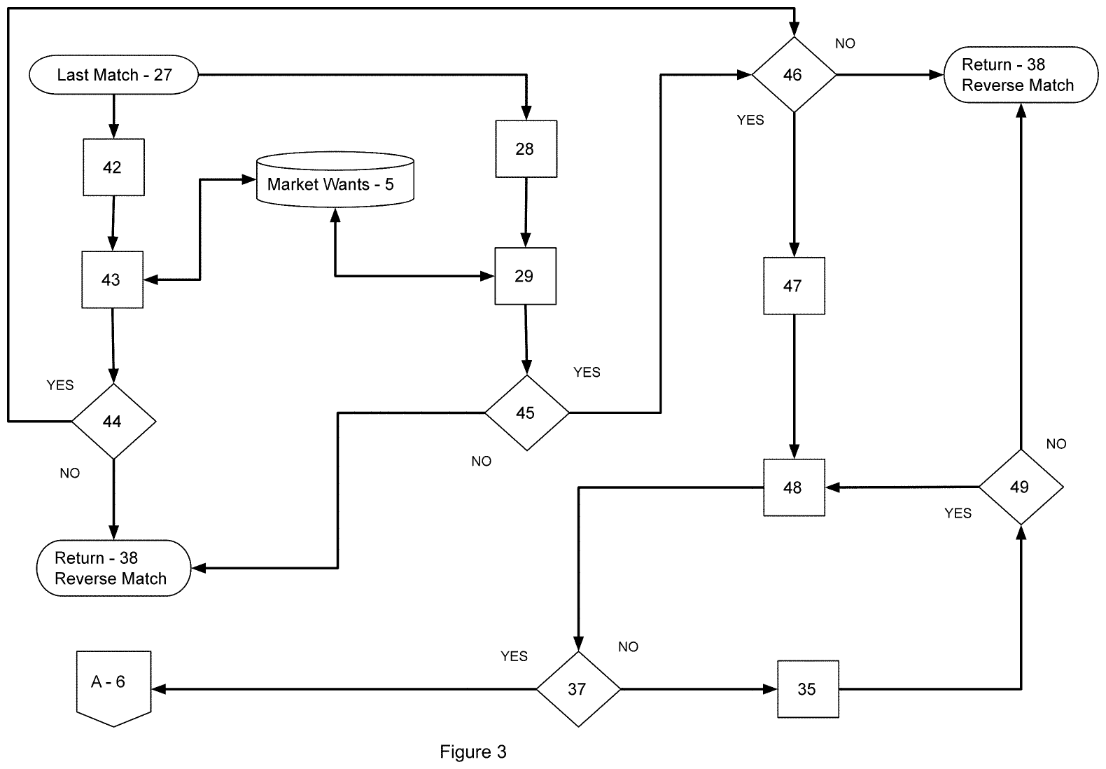

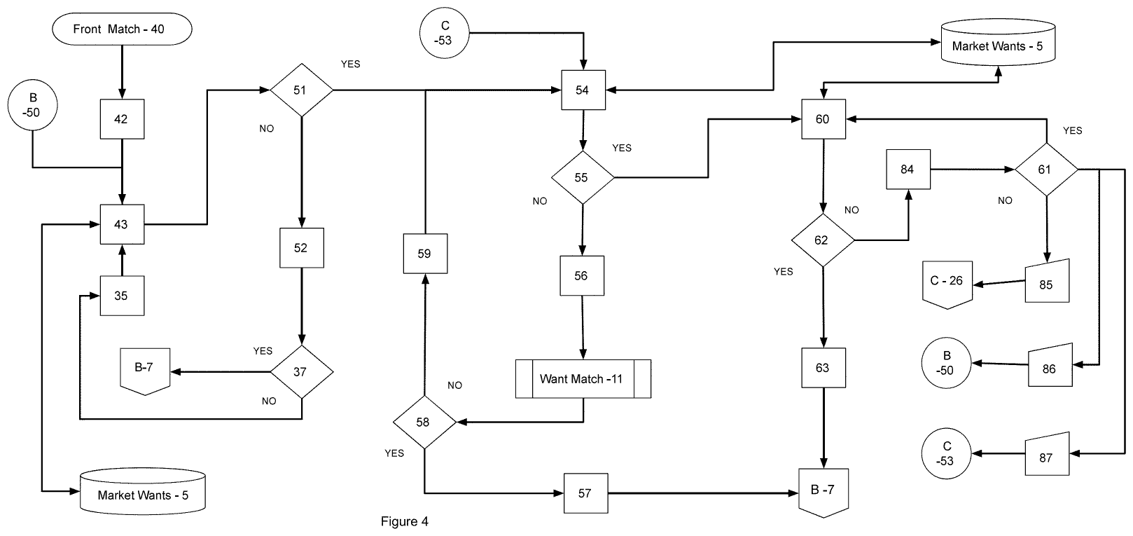

The multiple exchange construction process also utilizes sub-sequential subprocesses named“Front match” on FIG. 4 and “Last Match” on FIG. 3; to generate user links to be added at the front of a Multiple exchange construction on step 15. Thereby once the “Last Match” subprocess on FIG. 3 finds a user link, it connects with the “Multiple Exchange Engine” on FIG. 1, through the off-page connector A 6. Furthermore, once the “Front Match” subprocess on FIG. 4 finds a user link, it connects with the “Multiple Exchange Engine” on FIG. 1, through the off-page connector B 7.

In accordance to the user's input 13 discussed hereafter, a user initiating a multiple exchange offer, may select customizable filters to control price range and desired proximity from users in a multiple exchange chain. The filters also can modulate the amount of users involved within a multiple exchange chain; wherein the least amount of users participating would be three. Whereby, the amount of involved users could expand theoretically to any quantity of users, limited only by the available data within the “Market Wants” database 5. All subprocesses herein on FIGS. 2,3 and 4 will execute based on the user's input 13. These filters are utilized within the algorithm to constraint distance from users, equilibrate pricing within the exchange chain and facilitate an exchange process for a predetermined group of users 20.

Users evaluating electronically published listings can express their wants towards any goods and services, by clicking the “Want” plugin contained on each listing 1,2,3 and 4.

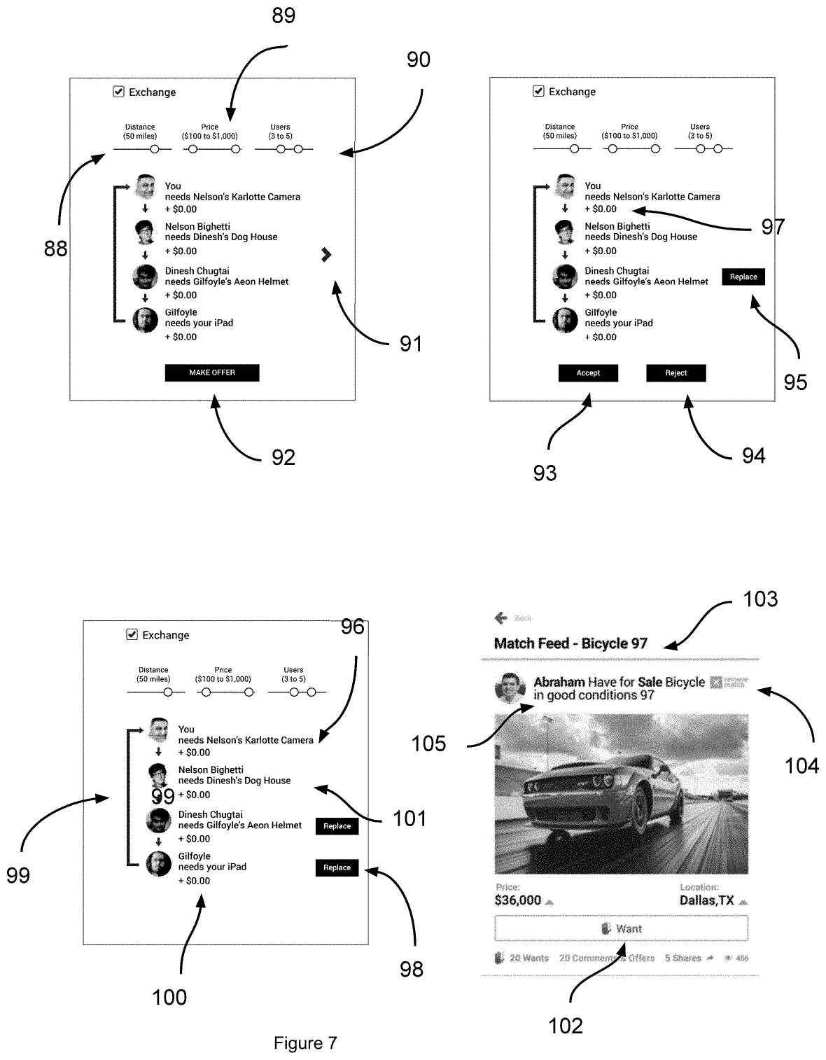

Said data is collected in real time through the “Market Needs” database 5, for all users; wherein the aforementioned data is extracted by the algorithm in order to generate a future multiple exchange chain, encompassing wanted items by the users within the same chain. Once the “Offer's Originator” executes the multiple exchange function 13, the automated algorithm will initially invoke the “Reverse Match” subprocess 16; extracting stored data from a number of random participants wanting the item offered by the “Offer's Originator”. Wherein the “Reverse Match” subprocess 16 will sequentially invoke the subprocesses named “Last Match” on FIG. 3, “Front Match” on FIG. 4, “Have Match” on FIG. 5 and “Want Match” on FIG. 6; to build all user links, to complete any missing user links, to replace any discarded user links or any combination thereof. Said subprocesses will become more apparent on the FIGS. 2,3,4,5 and 6 discussed hereinafter.

Wherein once a multiple exchange chain is generated, a graphical interphase is provided as illustrated on FIG. 7. Said graphical representation shows the respective item to be received and provided by each user; wherein the interphase, provides an offer acceptance button for each user involved within the multiple exchange chain 24. Supposing that all involved users within a multiple exchange chain, accepts their respective offers; consequently they will proceed to exchange their items simultaneously and close the transaction 23.

Supposing any user within the chain rejects the multiple exchange offer 21, then a user link is broken within the chain. Therefore, the automated algorithm invokes the subprocess “Reverse Match” 16 to replace any user links that gets rejected by users. It also replaces any item listing whose owner is inactive within the algorithm's platform 22, after a period of time predetermined by the algorithm's administrator. Furthermore, the algorithm also replaces, any items granted within a transaction or a multiple exchange chain 22. Wherein, supposing the source user link, namely, the “Offer's Originator” and the “Offer's Recipients” are discarded by the users or algorithm on step 17; the algorithm will stop constructing a multiple exchange chain 18. Whereby, the source user link can be discarded by the automated algorithm assuming the prior two aforementioned conditions on step 22. Furthermore, the “Offer's Originator” may also iterate a new multiple exchange chain through the user interphase on FIG. 7. Thus, preserving the source user link and automatically executing the algorithm on FIG. 1; to replace the remainder user links within a multiple exchange chain.

The source user link represents the foundation of the multiple exchange chain; wherein the algorithm always provides a wanted item to the “Offer's Originator” through a multiple exchange chain. The “Offer's Recipient” will connect with the “Offer's Originator” through an item encompassed within his inventory; thereby, creating a source link composed of two connected users. Wherein, given the graphical representation of a multiple exchange chain on FIG. 7; a source user link will be arranged by situating the “Offer's Originator” at the back of the “Offer's Recipient” in a multiple exchange construction. Wherein, said graphical representation will create a virtual loop with a directional rendering; whereby, the “Offer's Originator” connecting endings will be oriented towards the “Offer's Recipient”. This will become more apparent in FIG. 7 discussed hereinafter. From that point onward, the system iterates continuously adding new user links on steps 15 and 19 until the maximum number of users selected 20 in the multiple exchange interphase is reached.

### Reverse Match

The illustrated process on FIG. 2 in accordance with the principles of the present invention comprises an automated subprocess for adding user links at the back of a multiple exchange construction 19. Thereby, once a user link is generated through the subprocess herein, its connection endings will be aiming towards the back of the last user link within the chain. The “Reverse Match” subprocess on FIG. 2 encompasses further subprocesses, identified as “Last Match” on FIG. 3, “Front Match” on FIG. 4 and “Have Match” on FIG. 5, iterating in sequence, to generate user links for a multiple exchange chain.

The “Reverse Match” subprocess 16 utilizes the user number filter 13 and 25, to determine whether the iteration begins with the “Last Match” subprocess on FIG. 3 or continues with its own subprocess. Wherein, supposing a scenario, whereby the users number filter 13 is three, it will always initialize by invoking the “Last Match” subprocess on FIG. 3; given the source user link is comprised of two users. The “Last Match” subprocess on FIG. 3 is invoked by the “Reverse Match” subprocess 16 to find coincidence of needs on the last user link finishing the multiple exchange chain. Whereby, the “Last Match” subprocess on FIG. 3 will generate the last user link; wherein, the user located at the front of the multiple exchange chain, wants the item from the last linking user. Concurrently, the last linking user also wants, the item offered by the user at the back of the multiple exchange chain.

Furthermore, the off-page connector C 26 located within the “Reverse Match” subprocess on FIG. 2 is connected to the “Front Match” subprocess on FIG. 4; wherein, said connector, is utilized by the “Front Match” subprocess 40 after the execution of its first two cycles. Whereby, the “Front Match” subprocess 40 will connect to the “Reverse Match” subprocess 16, once new clicks are registered through the “Want” plugin 1,2,3 and 4. Said plugin data pertains to the item located at the back of the multiple exchange construction; thereby, the “Front Match” subprocess 40 can also initialize the “Reverse Match” subprocess 16. This process will become more apparent in the description of the “Front Match” subprocess on FIG. 4 discussed hereinafter.

Supposing a multiple exchange chain is comprised through a filter greater than three users 13 and 25, therefore the “Reverse Match” subprocess 16 will initially bypass the “Last Match” subprocess 27 and will proceed with its own automated execution. Thereon, given a scenario whereby the automated algorithm is building a multiple exchange transaction for five users, the process will develop in the following sequence. The subprocess “Reverse Match” 16 initial iteration will add a new user link with its connection endings aiming to the user at the back of the multiple exchange construction 19. Sequentially, the algorithm iterates a second time to find a new user link; wherein, its connection endings will aim towards the back of the newly added link. The “Reverse Match” subprocess 16 concludes by invoking the “Last Match” subprocess 27 to find the last user link finishing the multiple exchange chain. Wherein, all the items encompassed by the “Reverse Match” subprocess 16 and “Last Match” subprocess 27 will comply with the selected filters's parameters 13.

The “Reverse Match” subprocess 16 begins building new user links for a multiple exchange transaction in its initial cycle, by extracting data through the “Want” plugin on step 29. Hence, said plugin is connected to the item owned by the user at the back of the multiple exchange construction on step 28. Wherein, the collected “Want” data is stored in the “Market Wants” database 5 and is gathered through the item's plugin 1,2,3, and 4; depicting a plurality of users previously interested in said item. Therefore, further iterations invoking the “Reverse Match” subprocess 16 will extract data through the “Want” plugin 29 located on the item owned by the last user at the back of the multiple exchange construction 28.

At the inception, the automated algorithm scans the “Want” plugin data 1,2,3 and 4 on step 29, pertaining to the item owned by the “Offer's Originator” 13. From that scan onward, the algorithm will scan 29 the “Want” plugin data 1,2,3 and 4 pertaining to the item owned by the user located at the back of the multiple exchange construction on step 28. The subprocess herein isolate each and every user comprised within the “Want” plugin data 1,2,3,4 and scans their item inventory independently on step 33. The algorithm scans each and every item owned by the selected user on step 36, and discards any item on step 35 non conforming with the selected filters 37 and 13. Provided that a selected user doesn't own any active item 34 within his inventory, conforming with the selected filters 37 and 13; the user will be discarded within the multiple exchange construction on step 32. Wherein, once a user is discarded on step 32, the algorithm extracts a new user on step 29 and iterates steps 33,34,35 and 36 to find an item conforming with the filter's parameters 37 and 13.

Assuming the algorithm discarded 32 or depleted all users 31 contained within the “Want” plugin data 1,2,3 and 4 on step 29, it will deploy its secondary internal cycle. Wherein, said cycle comprises the identification of the category, price and location from the item owned by the user at the back of the multiple exchange construction on step 30. Wherein the “Reverse Match” subprocess 16 invokes the “Have Match” subprocess 8,64 to find “Want” listings within that category, conforming with the selected filters about location and price range 37 and 13. Bypassing a plurality of published “Want” listings 10 not matching directly with the item owned by the user at the back of the multiple exchange construction.

The “Have Match” subprocess 8 creates a “Want” listings inventory 72 based on the matching category, price and location for the item owned by the user at the back of the multiple exchange construction on step 30. The algorithm selects the “Want” listing 10 with the most relevant content on step 41, with respect to said item 30. Wherein, said “Want” listing 10 will be generated by the “Have Match” subprocess 8.

Thereby, assuming the item inventory pertaining to the user owning the “Want” listing 41, is discarded through steps 34,35,36 and 37; said user will be discarded on step by the “Reverse Match” subprocess 16. Furthermore, assuming said user don't own active items within his inventory 34, the algorithm will discard him from the multiple exchange construction on step 32.

Thus, once the “Reverse Match” subprocess 16 identifies an item conforming with the selected filters's parameters 13 and 37, it will return 38 to the “Multiple Exchange Engine” process on FIG. 1; to add the new user link at the back of the multiple exchange construction 19. Wherein the added user link represents a user owning an item conforming with the filter's parameters 13 and 37. Furthermore, the connection endings pertaining to said user link, will aim towards the last user link at the back of a multiple exchange construction 19.

Assuming the “Reverse Match” subprocess 16 couldn't find items through the “Have Match” subprocess 8, conforming with the selected filters 13 and 37; it will invoke 39 another subprocess designated as “Front Match” 40. The “Front Match” subprocess 40 will build user links at the front of a multiple exchange construction 15; this will become more apparent on FIG. 4 discussed hereinafter.

### Last Match

The illustrated process on FIG. 3 in accordance with the principles of the present invention comprises an automated process for adding the last user link completing the multiple exchange chain 15. Wherein, provided a user link is generated through the “Last Match” subprocess 27 herein, it will connect the users at the front and back of the multiple exchange chain to conclude the algorithm iterations.

The subprocess “Last Match” 27 is invoked by the “Reverse Engine” subprocess on FIG. 2, assuming the algorithm executes to find the last user link on step 25; based on the selected user quantity filter on the interphase 13.

The algorithm initialize by simultaneously extracting data pertaining to the user at the front 42 and of the item owned by user at the back of the multiple exchange construction on step 28. Wherein, the process commences by extracting information from the “Market Wants” database 5 pertaining to the user located at the front of the multiple exchange construction 42. By scanning all plugin data 1,2,3 and 4 based on clicks made towards a plurality of goods and services provided by other users on step 43. The algorithm simultaneously extracts plugin's data 29 pertaining to the item owned by the user at the back of the multiple exchange construction 28; wherein said plugin's data 29, constitutes an inventory of users owning a plurality of items.

Once both initial scanning are performed on steps 43 and 29 the algorithm validates the existence of stored data pertaining to the user in front 42 and the item owned by the user at the back of the multiple exchange construction 28. Specifically, said data is based on the click history towards a plurality of goods and services selected by the user at the front of the multiple exchange construction 43. Furthermore, said data is also based on the clicks history within the “Want” plugin 1,2,3 and 4 pertaining to the item owned by the user at the back of the multiple exchange construction 29.

Assuming no data is localized within any of the scans performed on steps 43 and 29, the algorithm will continue with steps 44 and 45 to conclude the “Last Match” subprocess 27. Wherein, once the “Last Match” subprocess 27 herein concludes, it returns 38 to the “Reverse Match” subprocess on FIG. 2.

Accordingly, once the algorithm finds stored data on steps 44 and 45, through the scans on steps 43 and 29; the algorithm validates the existence of common users contained within both scans 46.

Assuming failure to find users in common in both scans 46, it will conclude the “Last Match” subprocess 27 and the algorithm will return 38 to the “Reverse Match” subprocess on FIG. 2. Conversely, assuming the executed scans find users in common 46, step 47, it will create a consolidated item inventory owned by said users; based only of wanted items by the user at the front of the multiple exchange construction.

Therefore, once the consolidated inventory is generated 47, the algorithm selects one active item at a time on step 48, to validate conformance, with the selected filters's parameters 13 and 37. Wherein the algorithm discards items 35 failing to conform with the selected filters's parameters 13 and 37. Provided the algorithm depletes 49 the compiled inventory 47, the “Last Match” subprocess 27 will conclude and return 38 to the “Reverse Match” subprocess on FIG. 2. Thereby, once the algorithm finds an item conforming with the selected filters's parameters 13 and 37 through the “Last Match” subprocess 27; it returns to the “Multiple Exchange Engine” on FIG. 1 through connector A 6. Wherein, the “Multiple Exchange Engine” on FIG. 1 adds the item owner as a new user link at the front of multiple exchange construction on step 15.

Wherein, the “Last Match” subprocess 27 generate coincidence of wants for the user at the front of the multiple exchange construction and for the last user link. Wherein, the involved users find wanted items within a multiple exchange chain through the last user link; without exchanging items directly among them. Thereof, the “Last Match” 27 subprocess generates the last user link, that completes and closes the multiple exchange chain.

### Front Match

The illustrated process on FIG. 4 in accordance with the principles of the present invention, constitutes an automated process for adding user links at the front of a multiple exchange construction 15. Wherein assuming a user link is generated through the subprocess herein, the connection endings of the user link on front of the multiple exchange construction, will be aiming towards the newly added link.

The “Front Match” subprocess 40 is invoked through the “Reverse Match” subprocess on FIG. 2 once all iterations from the “Have Match” subprocess 8 and 39 are depleted. The “Front Match” subprocess 40 generates user links by extracting data from the user located at the front of the multiple exchange construction 42. User data is customized in real time and is extracted through the “Market Wants” database 5. The algorithm stores plugin data 1,2,3 and 4 any time a user clicks the “Want” plugin located on any published goods and services listings; it also stores content data from published goods and services listings 9,10. The “Front Match” subprocess 40 commences by scanning the user's clicks history over the “Want” plugin on step 43; wherein the algorithm only scans items within the “Market Wants” database 5 that are active and were not granted within other transactions.

The algorithm within the “Front Match” subprocess 40 extracts data from the user located at the front of the multiple exchange construction 42 by sequence. The first cycle extracts information from the “Market Wants” database 5 about the wanted goods and services by the user 43; wherein said goods and services were selected through their respective plugins 1,2,3 and 4. The algorithm validates the existence of active items selected by the user at the front of the multiple exchange construction on step 51.

Thereby, once an inventory of available active items is found, the algorithm will select one item at a time on step 52. Wherein the algorithm discards items 35 failing to conform with the selected filters's parameters 13 and 37

Thus, once the algorithm finds an item conforming with the selected filters's parameters 13 and 37 through the “Front Match” subprocess 40, it returns to the “Multiple Exchange Engine” on FIG. 1 through connector B 7. Wherein, the “Multiple Exchange Engine” on FIG. 1 adds the item owner as a new user link at the front of multiple exchange transaction on step 15.

Provided the first cycle fails to find an item 51 conforming with the filters's parameters 13 and 37, a secondary cycle extracts data from the created content by the user at the front of the multiple exchange construction 42, about his published “Want” listings 10 on step 54.

Thereby, the algorithm validates the existence of active “Want” listings 10 on step 55, pertaining to the user at the front of the multiple exchange construction 42. Thus, once an active “Want” listing 10 is found within the user's inventory, the algorithm selects one listing at a time on step 56 and invokes the “Want Match” subprocess 11 for said listing.

The “Want Match” subprocess 11 creates an item inventory 82 based on the category, price and location, in respect with the selected “Want” listing 10. Wherein, once the algorithm depletes the inventory of active items 58 generated by the “Want Match” subprocess 11; the algorithm will discard the selected “Want” listing for the multiple exchange construction on step 59.

Conversely assuming the “Want Match” subprocess 11 had generated a plurality of matching “Have” listings 9; the algorithm will select the “Have” listing 9 with the most relevant content on step 57 and 82, based on the selected “Want” listing 10. Thus, once the algorithm finds an item conforming with the selected filters's parameters 13 and 58 through the “Front Match” subprocess 40, it returns to the “Multiple Exchange Engine” on FIG. 1 through connector B 7. Wherein, the “Multiple Exchange Engine” on FIG. 1 adds the item owner as a new user link at the front of multiple exchange transaction on step 15. The “Want Match” subprocess 11 will become more apparent on FIG. 6 discussed hereinafter.

Sequentially, assuming the secondary cycle fails to find active “Want” listings 10 published by the user on step 55, a final cycle extracts information from the user at the front of multiple exchange construction 42 through his “Market Wants” database 5. Wherein the algorithm will quantify all the item categories wanted by the user and will select the category with the highest frequency on step 60. Thus, said category is found by combining stored “Want” plugin data 1,2,3,4 and published “Want” listings 10 by the user, to determine frequency on the most wanted items. Therein, the algorithm starts scanning random items within that category on step 62; wherein, said items simultaneously conforms with the filters about price and location

Therefore, assuming no random items are found within the selected category 62, the algorithm will discard said category 84 and will select the next most wanted item category by the user 60. Thereon, the algorithm will select distinct categories and discard 84 them, once it depletes all possible item alternatives within said category. Wherein, said method increases the probability in finding a new item conforming with the selected filters's parameters 13 and 62. Whereby, once the algorithm locates an item 63 conforming with the selected category and filters on step 62; it connects with the “Multiple Exchange Engine” on FIG. 1 through the off-page connector B 7. Therein, the algorithm places the new user link with its connection endings aiming towards the front of the multiple exchange construction 15.

Thereon, once the categories within the user “Market Wants” database 5 are depleted, the algorithm pauses until one of the steps hereafter 85,86 and 87 are triggered. The first event depicted on step 85, is triggered once the item owned by the user at the back of the multiple exchange construction, receives new clicks on its “Want” plugin 1,2,3 and 4. Wherein, the algorithm will connect through the off-page conector C 26 to the “Reverse Match” subprocess on FIG. 2; thereon, executing the same process-flow previously described on FIG. 2.

The second event depicted on step 86, is triggered once the user located at the front of the multiple exchange construction, clicks on the “Want” plugin located on other items 1,2,3 and 4. Wherein, the algorithm connects through connector B 50, to the first cycle contained within the “Front Match” subprocess 40; thereon, executing the same process-flow previously described on FIG. 4.

The third event depicted on step 87, is triggered once the user located at the front of the multiple exchange construction, publishes a new “Want” listing 10. Wherein, the algorithm connects through connector C 53, to the second cycle contained within the “Front Match” subprocess 40; thereon, executing the same process-flow previously described on FIG. 4.

### Have Match

The illustrated process on FIG. 5 in accordance with the principles of the present invention constitutes an automated process generating a plurality of matches in real time 72; any time a “Have” listing 9 is electronically published. Wherein the “Have Match” subprocess 8 creates a direct match among “Have” 9 and “Want” 10 listings; by connecting two users before three users or more can be connected through the “Multiple Exchange Engine” on FIG. 1. This enables the algorithm to expedite the user links generation process, by connecting a multitude of users directly in real time; as opposed to connect them indirectly through a multiple exchange chain.

Therefore, the algorithm generates matching connections in real time, whereby all “Want” listings 10 will match the content 70 within the published “Have” listings 9. Wherein the algorithm arranges said “Want” match inventory, within the user's interphase, through a list attached beneath the electronically published “Have” listing 72.

The algorithm automatically invokes the “Have Match” subprocess 8, any time a random user creates an electronically published item within the user interphase. Wherein said item is constituted herein as a “Have” listing 9, that may encompass any goods and services provided within the free market.

Whereby this subprocess occurs in real time and is only limited by the inventory of “Want” listings 10 contained within the “Market Wants” database 5; it is also constrained by the amount of wanted results selected by the user through the interphase 74.

The “Have Match” subprocess 8 validates on its initial step whether it was invoked by a “Have” listing 9 publishing or through the “Reverse Match” subprocess 16 on step 64. Wherein, assuming the “Have Match” subprocess 8 had been invoked by the “Reverse Match” subprocess 16, it leads directly to step 72. Thereby, it utilizes the results from the “Have Match” subprocess 8 execution, previously invoked through the publishing of a “Have” listing 9. Thereon, the algorithm will implement a second validation on step 64 to confirm whether it was invoked by the “Reverse Match” subprocess 16. Wherein, assuming a positive confirmation, the algorithm will return 38 to the “Reverse Match” subprocess 16 and utilize the data obtained from step 72. The process steps to generate said results in step 72 will become more apparent in the descriptions hereafter.

The algorithm initializes the “Have Match” subprocess 8 by validating first whether the item's listing is active on step 65, by verifying user inactivity within the interphase by a set period of time; predefined by the algorithm's administrator. Whereby, given an electronically published item that is identified as active 65, the algorithm will commence its real time process to arrange all the matching “Want” listings 10 inventory beneath the “Have” listing 9 on step 72.

Conversely, once the electronically published item is identified through the algorithm as inactive on step 65, the algorithm stops generating “Want” match alternatives 75 in real time.

The “Have Match” subprocess 8 commences by extracting data from an electronically published “Have” listing 9, to identify its specific category, location and price on step 67. The algorithm will store information in the “Matching Want Listings” database 66, about “Want” listings 10 conforming with the category, location and price in allusion to the published “Have” listing 9. Wherein said listings are contained within the “Market Wants” database 5. Furthermore, the algorithm will exclude from the scan on step 67, all the “Want” listings 10 already encompassed within the “Matching Want Listings” database 66; whereby, each electronically published “Have” listing 9 will posses its own “Matching Want Listing” database 66.

Thereon, step 67 bypasses a multitude of published “Want” listings 10 not matching directly with the electronically published “Have” listing 9. Furthermore, assuming all “Want” listings 10 alternatives contained within the “Market Wants” database 5 are depleted 69, the algorithm will stop searching for additional matches 75. Wherein, the algorithm will re-initiate its scanning process 67, once a random user publishes a “Want” listing 10 within the same category on step 73.

The algorithm will automatically update the “Matching Want Listings” database 66 on step 22, by discarding any inactive or traded items, encompassed within said database. The “Have Match” subprocess 8 will also automatically update the “Want” inventory on step 72 through its algorithm, by discarding 22 inactive or traded “Want” listings 10. Wherein, the algorithm commences executing again to replace said “Want” listings 10 on step 74. Furthermore, a user may also discard manually 68 any “Want” listing 10 encompassed within his inventory on step 72; therefore, the algorithm will commence to execute again to replace said “Want” listings 10 on step 74.

Thereon, once the algorithm identifies new matching “Want” listings 10 on step 69, it will invoke the “Matching Want Listings” database 66. Wherein, the algorithm will use said data to compare content 70 among a “Have” listing 9, correlated with the content of a plurality of “Want” listings 10. Therefore, the algorithm will quantify the amount of matching words between contents for each and every “Want” listing 10 on step 70.

Furthermore, the algorithm will arrange the matching content from step 70, by sorting the resultant “Want” listings 10 in order of relevance 71. Wherein, said “Want” listings 10 will be organized in descending order 71 based on the amount of matching words among the content of a “Have” 9 and “Want” listing 10. As a final step, the algorithm will create an inventory 72 of matching “Want” listings 10 attached to the “Have” listing 9, based on the order generated on step 71.

Thereon, the algorithm will quantify the inventory of “Want” listings 10 attached to the “Have” listing 9 on step 74; whereby, once the selected amount of wanted listings is reached, the algorithm stops 75 locating “Want” listings 10 in real time.

### Want Match

The illustrated process on FIG. 6 in accordance with the principles of the present invention constitutes an automated process generating a plurality of matches in real time 82; any time a “Want” listing 10 is electronically published. Wherein the “Want Match” subprocess 11 creates a direct match among “Have” 9 and “Want” 10 listings; by connecting two users before three users or more can be connected through the “Multiple Exchange Engine” on FIG. 1. This allows the algorithm to expedite the user links generation process, by connecting a multitude of users directly in real time; as opposed to connect them indirectly through a multiple exchange chain.

Therefore, the algorithm creates matching connections in real time, whereby all “Have” listings 9 will match the content 81 within the published “Want” listings 10. Wherein the algorithm arranges said “Have” match inventory, within the user's interphase, through a list attached beneath the electronically published “Have” listing 82.

The algorithm automatically invokes the “Want Match” subprocess 11, any time a random user creates an electronically published search within the user interphase. Wherein said search is constituted herein as a “Want” listing 10, that may encompass any goods and services provided within the free market.

Whereby this subprocess occurs in real time and is only limited by the inventory of “Have” listings 9 contained within the “Market Wants” database 5; it is also constrained by the amount of wanted results selected by the user through the interphase 74.

The “Want Match” subprocess 11 validates on its initial step whether it was invoked by a “Want” listing 10 publishing or through the “Front Match” subprocess 40 on step 76. Wherein, provided the “Want Match” subprocess 11 had been invoked by the “Front Match” subprocess 40, it leads directly to step 82. Thereby, it utilizes the results from the “Want Match” subprocess 11 execution, previously invoked through a “Want” listing 10 creation. Furthermore, the algorithm will implement a second validation on step 76 to confirm whether it was invoked by the “Front Match” subprocess 40. Wherein, given a positive confirmation, the algorithm will return 38 to the “Front Match” subprocess 40 and utilize the data obtained from step 82. The process steps to generate said results on step 82 will become more apparent in the descriptions hereafter.

The algorithm initializes the “Want Match” subprocess 11 by validating first whether the search's listing is active on step 77, by verifying user inactivity within the interphase by a set period of time; predefined by the algorithm's administrator. Whereby, assuming an electronically published search is active 77, the algorithm commences its real time process to arrange all the matching “Have” listings 9 inventory beneath the “Want” listing 10 on step 82.

Conversely, assuming an electronically published search is inactive on step 77, the algorithm stops generating “Want” match alternatives 75 in real time.

The “Want Match” subprocess 11 commences by extracting data from an electronically published “Want” listing 10, to identify its specific category, location and price on step 79. The algorithm will store information in the “Matching Have Listings” database 78, about all the “Have” listings 9 conforming with the category, location and price in allusion to the “Want” listing 10. Wherein said listings are encompassed within the “Market Wants” database 5. Furthermore, the algorithm will exclude from the scan on step 79, all the “Have” listings 9 already encompassed within the “Matching Have Listings” database 78. Whereby, each electronically published “Want” listing 10 will posses its own “Matching Have Listing” database 78.

Thereon, step 79 bypasses a multitude of published “Have” listings 9 not matching directly with the electronically published “Want” listing 10. Furthermore, once all “Have” listings 9 alternatives encompassed within the “Market Wants” database 5 are depleted 80, the algorithm will stop searching for additional matches 75. Wherein, the algorithm will re-initiate its scanning process 79, once a random user publishes a “Have” listing 9 within the same category on step 83.

The algorithm will automatically update the “Matching Have Listings” database 78 on step 22, by discarding any inactive or traded items, encompassed within said database. The “Want Match” subprocess 11 will also automatically update the “Have” inventory on step 82 through its algorithm, by discarding 22 inactive or traded “Have” listings 9; wherein the algorithm commence executing again to replace said “Have” listings 9 on step 74. Thereby, a user may also discard manually 68 any “Have” listing 9 contained within his inventory on step 82; therefore, the algorithm will commence executing again to replace said “Have” listings 9 on step 74.

Thereon, once the algorithm identifies new matching “Have” listings 9 on step 80, it will invoke the “Matching Have Listings” database 78. Wherein, the algorithm will use said data to compare content 81 among a “Want” listing 10, correlating with the content of a plurality of “Have” listings 9. Therefore, the algorithm will quantify the amount of matching words between contents for each and every “Have” listing 9 on step 81.

Furthermore, the algorithm will arrange the matching content from step 81, by sorting the resultant “Have” listings 9 in order of relevance 71. Wherein, said “Have” listings 9 will be organized in descending order 71 based on the amount of matching words among the content of a “Have” 9 and “Want” listing 10. As a final step, the algorithm will create an inventory 82 of matching “Have” listings 9 attached to the “Want” listing 10, based on the order generated on step 71.

Thereon, the algorithm will quantify the inventory of “Have” listings 9 attached to the “Want” listing 10 on step 74; whereby, once the selected amount of wanted listings is reached, the algorithm stops 75 locating “Have” listings 9 in real time.

### User Interphase

The illustrated graphical representation on FIG. 7 in accordance with the principles of the present invention constitutes a user's interphase that initialize the algorithm's process to construct a multiple exchange chain. Wherein, assuming a user had selected through the user interphase, the required filter inputs: distance 88, price and users 90; the algorithm commence invoking the subprocesses on FIGS. 1, 2, 3, 4, 5 and 6 to generate a multiple exchange chain.

Wherein, the interphase filters are designed to constraint: maximum desired distance among users 88, items price range 89 and number of desired users 90 within a multiple exchange chain.

Assuming all filters's parameters: distance, 88, price 89 and users 90 are selected, the algorithm scans the inventory of items pertaining to the “Offer's Originator” 13,96; to identify the goods and services conforming with the selected price range 89. Wherein, the “Offer's Originator” 13,96 will select an item 100 within his inventory, to be employed in a multiple exchange construction. Assuming the “Offer's Originator” don't posses items conforming with the selected price range 89; said user may customize a new price range 89 within the user's interphase, to find a conforming item within his inventory and execute the “Multiple Exchange Engine” algorithm on FIG. 1.

Once the “Offer's Originator” 13,96 selects an item 100 conforming with the desired price range 89, the algorithm will invoke the “Multiple Exchange Engine” on FIG. 1 to generate a multiple exchange chain. Therefore, the user's interphase will generate a graphical representation of the final multiple exchange chain 99; comprising all involved users and their respective exchanged items. Wherein, once a multiple exchange chain is generated, a notification is send to all involved users. Said involved users, may scrutinize their multiple exchange chain 99 and make a decision based on the four choices hereafter: “Accept” 93, “Reject” 94, “Replace” 95 or “Counter” 97 their received offer through a multiple exchange chain. Assuming all involved users within a multiple exchange chain “Accepts” 93 their respective offers; subsequently, all involved items will be reserved within that transaction by the “Automated Match Engine” on FIG. 1. Therefore, said items will not be utilized by the algorithm for further constructions. Wherein all user links utilizing said items within an accepted multiple exchange chain, are removed and replaced 22,17 by new user links generated by the “Multiple Exchange Engine” on FIG. 1.

Assuming any of the involved users within a multiple exchange chain “Rejects” 94 his received offer, said user will be discarded within that multiple exchange chain; therefore, the “Automated Match Engine” process on FIG. 1 will be invoked to add said missing user link. Thereof, all remaining user links within the multiple exchange chain will keep intact.

Thereby, users within a multiple exchange chain choosing the “Counter Offer” option 97 through the interphase, may request additional items, request to add money or request a change on the terms and conditions of any service; wherein said request is addressed to the user link located at his front within the multiple exchange chain.

Furthermore, any users within a multiple exchange chain choosing the “Replace” option 95, may replace the user link embodying his received offer; whereby, the “Multiple Exchange Engine” process on FIG. 1 will replace the selected user link. The “Replace” option 95 will shift its location within a graphical rendering, based on the user position within a multiple exchange chain. Wherein for the “Offer's Originator” 13,96 said user may choose to “Replace” 95 any user links within the multiple exchange chain 98, excluding the item pertaining to the “Offer's Recipient” 101. Thereof, all remainder users within a multiple exchange chain, may “Replace” 95 the user link embodying their respective offers; excluding the item 100 pertaining to the “Offer's Originator” 13,96, considered part of the source link.

Wherein all user links 99, including the source link 96,101 are solely discarded under two conditions: an item embodied within a user link, was granted within another transaction 22 or the item owner is inactive 22 within the algorithm's interphase for a predefined period of time; determined by the algorithm's administrator. Wherein, the “Offer's Originator” 13,96 may choose 91 among a plurality of multiple exchange chains generated by the algorithm; to produce an offer 92 through the user's interphase.

Wherein, assuming the graphical representation of a multiple exchange chain 99; a source user link 96,101 will be arranged by situating the “Offer's Originator” 13,96 at the back of the “Offer's Recipient” 101 in a multiple exchange construction. Wherein, said graphical representation 99 will create a virtual loop with a directional rendering; whereby, the connection endings of the “Offer's Originator” 13,96 will be aiming towards the “Offer's Recipient” 101. Consequently, said directional rendering will be displayed for all users within a multiple exchange chain 99; depicting the item exchange flow among users.

The illustrated graphical interphase 103 constitutes the preferred embodiment to execute the direct match algorithm. Wherein, all matching “Want” and “Have” listings will be sorted through correlation of their content 105 as discussed on FIGS. 5 and 6. Assuming a user utilizes the “remove match” 104 function, this will preclude a listing to be illustrated as a matching result for a particular listing. The algorithm will automatically replace the discarded listing as discussed on FIGS. 5 and 6; wherein, it will simultaneously update the “Market Needs” database. The illustrated graphical interphase on 102 embodies the “Want” plugin utilized through FIGS. 1,2,3 and 4. to execute the algorithm iterations.

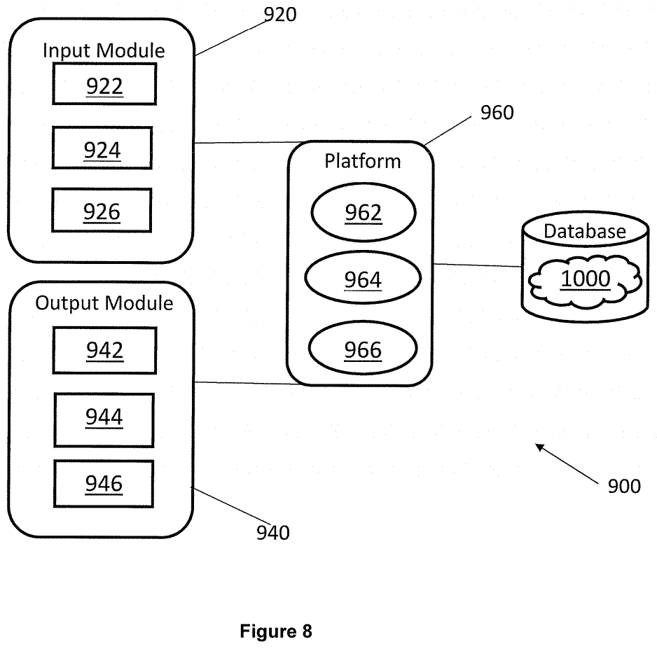

FIG. 8. In general, as mentioned before, the embodiments of the present disclosure may be implemented, through the use of general-programming languages (such as C or C++). The program code can be disposed in any known computer-readable medium including semiconductor, magnetic disk, or optical disk (such as CD-ROM, DVD-ROM). For example, the multiple exchange engine (MEE) 14, Have Match (HM) 8 and Want Match (WM)11 is disposed 900 in a computer readable medium as a computing platform 960. In the embodiment of FIG. 8, the computing platform 960 may include a cloud computing provider, a standalone web-server, a personal computer (PC), a mainframe computer, or a laptop computer configured to perform various functions and oper-ations. That is, computing platform 960 may include software functionality and hardware capabilities to implement the features of the present disclosure according to an embodiment of the disclosure. Computing platform 960 may be implemented, for example, by a general purpose apparatus selectively activated or configured by software stored in memory of the apparatus, or may be a specially constructed computing platform for carrying out the features and oper-ations of the MEE 14, HM 8 and WM 11,900. It is contemplated, that the computing platform 960 may be accessible via a web browser without the need to download and install an application on every device in which the user desires to expe-rience the multiple exchange engine features in the manner enabled by the present disclosure. That is the model engineering tool features of the present disclosure reside in the cloud and thus are executable over a web browser or may reside locally, such as in a smart phone application down-loaded from an application marketplace or preloaded by the smart phone's manufacturer. However the MEE 14, HM 8 and WM 11 may be accessible through a computing platform 960 having locally executed software to perform the model engineering tool features of the present disclosure.

In order to perform these tasks, computing platform 960 may also be implemented or provided with a wide variety of components or subsystems including, for example, one or more of the following: a processor 962, a co-processor 964, a register 966, and/or other data processing devices and subsystems. Computing platform 960 may also communicate or transfer model-related data as well as and feedback provided by the user or third parties via input module 920 and/or output module 940 through the use of wired connections, wireless connections or other means of communication, as depicted in FIG. 8.

In an exemplary embodiment, a firewall may prevent access to the computer platform 960 by unauthorized exter-nal entities. It is further contemplated that computing platform 960 may require user authentication, such as pass-word verification, biometrics, pattern recognition, speech recognition or similar means, in order to prevent unauthorized users from gaining access to sensitive information, files, and recursive ontology-based engineering preferences associated with a particular individual.

It is further contemplated that communication between computing platform 960 and input and output modules 920, 940 can be achieved through the use of a network architecture. In such an embodiment, the network architecture may include, alone or in any suitable combination, a telephone-based network (such as a PBX or POTS), a local area network (LAN), a wide area network (WAN), a VPN, a dedicated intranet, and/or the Internet. Further, the network architecture may include any suitable combination of wired and/or wireless components and systems necessary in order to carry out the present disclosure. By using dedicated communication links or a shared network architecture, computing platform 960 may be located in the same location or at a location geographically remote from input and/or output modules 920, 940.

Input module 920 may include a wide variety of devices to receive and/or provide the data as input to computing platform 960. As illustrated in FIG. 8, input module 920 may include an input device 922, a storage device 924, and/or a network interface 926. Input device 922 may include a keyboard, mouse, touch screen, stylus, touchpad, disk drive, video camera, magnetic card reader, or any other suitable input device for communicating data to computing platform 960.

Memory 1000 may be implemented with various forms of memory or storage devices, such as read-only memory (ROM) devices and random access memory (RAM) devices. Storage device 924 may include a memory tape, disk drive, a flash memory card, an SD card or a microSD card for reading and providing data (including video files) as input to computing platform 960. Network interface 926 may receive data over a network (such as a LAN, a WAN, a mobile network, such as EDVO, 3G, 4G, GSM, an intranet or the Internet) and provide the same data as input to computing platform 960. For example, network interface 926 may be selectively connected or connectable to a public or private database for purposes of receiving information about one or more users, user files, video clips and other related data from computing platform 960.

Output module 940 may include a display 942, a printer device 944, and/or a network interface 946 for receiving the information provided as output from computing platform 960. As indicated above, the output module 940 from computing platform 960 may include a display showing the MEE 14, HM 8 and WM 11 tools in the manner described herein. The output from computing platform 960 may be displayed or viewed through display 942 (such as a CRT, LCD, CSTN, TFT, TFD, OLED, capacitive, resistive, AMOLED, super AMOLED, haptic/tactile, Gorilla glass or Retina type) and printer device 944. Network interface 946 may also facilitate the communication of the output from computing platform 960 over a network (such as a LAN, a WAN, a mobile network, such as BDYO, 3G, 4G, GSM, an intranet or the Internet) to remote locations for debugging, reviewing or providing backup.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

The invention claimed is:

1. A computer-readable method that iterates automatically, to generate user links in real time by means of their published inventories; comprising a direct or indirect match among at least two users, wherein said users match generates links between users, wherein said users links are generated in real time for a plurality of users wanting to do transactions, exchange goods and services with or without monetary exchange, wherein at least two users communicate via a communication network through a non-transitory computer-readable medium, wherein said non-transitory computer-readable medium comprises instructions stored thereon, that when executed on a processor, perform the steps of:
Generating wanted items options by users, within an exchange chain or as a direct matching result, extracting data from an electronically published first listing, wherein said first listing is defined as a “Want” listing, extracting data from an electronically published second listing, wherein said second listing is defined as a “Have” listing and extracting data from an electronic plugin located on electronically published item's listings, wherein the extracting method comprises:
a. A first subprocess that executes itself automatically any time a “Have” listing is electronically published, wherein said subprocess locates matching criteria among a plurality of random “Want” listings and creates an inventory of direct matching results; wherein, said direct matching results are arranged by relevance and correlate to a published “Have” listing.
b. A second subprocess that executes itself automatically any time a “Want” listing is electronically published, wherein said second subprocess locates matching criteria among a plurality of random “Have” listings and creates an inventory of direct matching results; wherein, said results are arranged by relevance and correlate to a published “Want” listing.
c. A user interphase executing a multiple exchange engine, wherein said execution is performed through the submission of an offer, including an offered item by an Offer's Originator for the multiple exchange construction; wherein the filters's inputs are the users's location range, items's price range and the maximum amount of desired users within a multiple exchange chain; wherein, executing a multiple exchange engine commences iterating in sequence a first, second and third subprocess to generate a graphical rendering of a multiple exchange chain.

2. The method for the generation of a multiple exchange chain according to claim 1, wherein a first subprocess extracts data from the item owned by the user at the back of the multiple exchange construction; wherein said data was gathered through a plugin located on the item's digital listing; wherein said data comprises a list of users wanting said item; wherein, each user could own a plurality of items conforming with the selected filters's parameters; wherein, the extraction is completed one user at a time from said list of users, wherein the user's inventory is scanned and validated; wherein, the first subprocess selects just one item conforming with the filters's parameters and adds its owner at the back of the multiple exchange construction.

3. The method for the generation of a multiple exchange chain according to claim 1, comprising a secondary cycle within the first subprocess, wherein said secondary cycle scans data from electronically published “Want” listings utilizing the subprocess on claim 1a; wherein, the first subprocess only scans “Want” listings conforming with the item's criteria about category, location and price range. Wherein, once the first subprocess successfully locates a “Want” listing, it scans the item inventory from the listing's owner; validating whether any of his items conforms with the selected filters's parameters and adds the owner at the back of the multiple exchange construction.

4. The method for the generation of a multiple exchange chain according to claim 1, wherein a second subprocess extracts data from the user in front of the multiple exchange construction; wherein said data was stored in a match engine database pertaining to said user; wherein said data represents items wanted by that user that may conform with the selected filters's parameters; wherein, the second subprocess selects just one item conforming with the filters's parameters and adds its owner at the front of the multiple exchange construction.

5. The method for the generation of a multiple exchange chain according to claim 1, wherein the second subprocess comprises a secondary cycle, wherein said secondary cycle scans data from electronically published “Have” listings utilizing the subprocess on claim 1b; wherein, the second subprocess only selects “Have” listings conforming with the criteria about category, location and price range; wherein, the second subprocess selects just one “Have” listing conforming with the filters's parameters and adds its owner at the front of the multiple exchange construction.

6. The method for the generation of a multiple exchange chain according to claim 1, wherein the second subprocess comprises a final cycle, wherein said final cycle scans data from the match engine database pertaining to the user located at the front of a multiple exchange construction; quantifies the most wanted categories, in accordance with the item selections executed through a plugin located on electronically published listings; wherein the second subprocess arranges by relevance order, the most wanted categories and selects the top category; wherein the second subprocess scans random item listings conforming with the selected filters's parameters about category, location and price range; wherein, the second subprocess adds the item owner at the front of the multiple exchange construction.

7. The method for the generation of a multiple exchange chain according to claim 6, wherein assuming no items are found within said top category, the second subprocess selects the next most wanted category on the list and so forth.

8. The method for the generation of a multiple exchange chain according to claim 1, wherein a third subprocess extracts data simultaneously from the user at front and the item owned by the user at the back of the multiple exchange construction; wherein, said data was stored respectively in the match engine database pertaining to said user; wherein, the third subprocess finds users in common in both scanning and creates a consolidated inventory of their published items; wherein, said consolidated inventory consists only of items wanted by the user at the front of the multiple exchange construction; wherein, the third subprocess selects just one item conforming with the filters's parameters and adds its owner at the front of the multiple exchange construction to close the chain.

9. The method for the generation of a direct match according to claim 1, comprising the bypassing subprocesses on claim 1a and 1b; wherein, the bypassing subprocesses automatically generate a plurality of links of two users with a direct match, displayed to the involved users and stored within a database; wherein said database may be utilized for the future construction of a multiple exchange chain; and wherein, said user links comprises published items listings that may expire in a predefined period of time, become incorporated in just one accepted transaction, be discarded by users and automatically replaced with new matching options.

10. The method for the generation of a multiple exchange chain according to claim 1, further comprising a method whereby the algorithm is executed to generate exchange chains between three or more users; wherein said multiple exchange chain can be manually or automatically replaced with new exchange chains.

11. The method for the generation of a direct match according to claims 1a,1b and 9 creating real-time connections among users by employing their respective active “Have” and “Want” item inventories, that may be manually or automatically discarded; wherein the match engine database stores all wanted items by each user and extracts said data generating links among a multitude of users.

12. The method for the generation of a multiple exchange chain according to claim 1, further comprising a method whereby the plugin constitutes a connection tool; wherein said data comprises market interest among users in real time for a multitude of goods and services, in a plurality of geographic areas.

13. The method for the generation of a multiple exchange chain according to claim 1, further comprising a method whereby users selecting wanted items through the plugin, constitutes a user link with the item's owner; wherein said user link will be stored in the match engine database, for future multiple exchange constructions.

14. The method for the generation of a multiple exchange chain according to claim 1, further comprising a method whereby items not directly selected by the user through the plugin, may be included in a multiple exchange construction based on the listings inventory owned by the user.

15. The method for the generation of a multiple exchange chain according to claim 12 further comprising a method whereby a multitude of users may customize their goods and services needs in real time; without the need for an electronic data input format.

16. The method for the generation of a multiple exchange chain according to claim 1, further comprising a method wherein the “Offer's Originator” offers at least one item within his inventory; wherein, the user interphase only display items within the “Offer Originator” inventory, conforming with his selected filter parameters.

17. The method for the generation of a multiple exchange chain according to claim 2 further comprising a method wherein the first step within the first subprocess validate whether its current iteration is geared to find the last user link; closing the multiple exchange chain.

18. The method for the generation of a multiple exchange chain according to claim 17, wherein, for the last user link, a third subprocess on claim 8 is executed to conclude a multiple exchange chain.

19. The method for the generation of a multiple exchange chain according to claim 1 further comprising a method wherein the item owned by the “Offer's Originator” and the item pertaining to the “Offer's Recipient” are declared as the source link within a multiple exchange construction.

20. The method to automatically update a multiple exchange chain according to claim 1 further comprising a method wherein all user links within a multiple exchange chain can be automatically replaced based on availability and the defined time constraints.
